(19) United States
(12) Patent Application Publication
(10) Pub. No.: US 2026/0222784 A1
(43) Pub. Date: Jul. 30, 2026

(54) RESTRICTING MOVEMENT OF ANIMALS

(71) Applicant: Nofence AS, Batnfjordsøra (NO)

(72) Inventors: Fabien Lepoutre, Batnfjordsøra (NO); André Naess, Batnfjordsøra (NO); Joar Gjersund, Batnfjordsøra (NO); Paul Nautré, Batnfjordsøra (NO)

(21) Appl. No.: 19/430,950

(22) Filed: Dec. 23, 2025

(30) Foreign Application Priority Data
Jan. 29, 2025 (GB) 2501312.9

(51) Int. Cl. H04W 4/80; A01K 3/00; A01K 27/00; A01K 29/00; H04W 84/20

(52) U.S. Cl. CPC H04W 4/80; A01K 3/00; A01K 27/009; A01K 29/005; H04W 84/20

(57) ABSTRACT

A system for restricting movement of animals within a perimeter and a wearable device for attaching to animals are disclosed. The system includes: wearable devices; and a central server which communicates with the wearable devices via a data network. The wearable devices each include: a first transceiver for sending and receiving data to/from the data network; a second transceiver for sending and receiving data via a short-range communication protocol; a GNSS module for determining a location of the wearable device; a correction module which provides a stimulus to the animal based on distance from the perimeter. The wearable devices are arranged to regularly rotate which are active for receiving data from the central server via the data network. The active wearable device(s) receive the data from the data network, and transmit the data via the short-range communication protocol. The inactive wearable device(s) receive the data via the short-range communication protocol.

### CROSS REFERENCE TO RELATED APPLICATION(S

This application claims priority to United Kingdom Patent Application Serial No. 2501312.9, entitled “Inter-collar communications,” filed January 29, 2025, the entire disclosure of which is incorporated herein by reference.

### TECHNICAL FIELD

This disclosure relates to restricting movement of animals within a geographical perimeter.

### BACKGROUND

Historically the movement of livestock animals was restricted by the use of physical fences, which allowed herd managers to keep the animals within a fixed area. More recently, the Applicant has pioneered novel approaches to humanely restricting movement of animals using wearable devices attached to the animals, for example herd animals like sheep and cows. The wearable devices monitor the geographical location of the animals and can provide a stimulus to the animal when they approach a boundary to help the animal to understand where it should reside. This means the physical fences may no longer be required, meaning animals can be monitored and grazing areas changed remotely.

For remote monitoring and control to be implemented, the animal wearable devices typically each have transceivers for connectivity with remote data networks, commonly with cellular networks. A central server sends and receives data to/from the wearable devices. For example, data relating to the movement and location of the animals may be sent from a wearable device to the server, and data relating to the current pasture area may be sent from a server to each wearable device.

It will be appreciated that such wearable devices are limited in size and weight by their nature as wearable devices, and the importance of ensuring that they are comfortable to wear. Battery life is therefore of particular concern as recharging or replacing batteries is difficult.

### SUMMARY

The present disclosure seeks to bring improvements in this area.

According to a first aspect of the disclosure there is provided a system for restricting movement of animals within a geographical perimeter, the system comprising:
a) a plurality of wearable devices, each wearable device being configured to be attached to an animal, and comprising:
   i) a first transceiver arrangement for sending and receiving data to/from a remote data network;
   ii) a second transceiver arrangement for sending and receiving data via a short-range communication protocol (e.g., a short-range wireless protocol);
   iii) a GNSS module for determining a geographical location of the wearable device;
   iv) a correction module arranged to provide a stimulus to the animal based on a distance of the geographical location from the geographical perimeter; and
   v) a power supply; and
b) a central server arranged to communicate with the plurality of wearable devices via the remote data network, the plurality of wearable devices being arranged to regularly rotate which one or more of them is active for receiving data from the central server via the remote data network; wherein:
   i) the central server is arranged to transmit data via the remote data network;
   ii) the active wearable device(s) is(are) arranged to receive the data from the remote data network, and to transmit the data via the short-range communication protocol; and
   iii) at least one inactive wearable device which is not active for receiving data from the central server is arranged to receive the data via the short-range communication protocol.

Thus it will be seen by those skilled in the art that in accordance with the disclosure, rather than each of the wearable devices needing to maintain separate connections with the server, the wearable devices can receive data indirectly via a device which is in communication with the server. This means that a given wearable device can significantly reduce how often it is in contact with the remote data network without a commensurate increase in the amount of time it takes for the device to receive data from the network. Instead embodiments of the disclosure allow data from the server to be effectively communicated to other wearable devices without the need to wait for it or them to become active according to the regular rotation.

The Applicant has identified that regularly rotating the active wearable device in accordance with the disclosure can provide a significant reduction in overall power consumption for each wearable device since connecting to the remote data network uses a significant amount of power. To give an illustrative example in a herd of 100 animals, where it is determined to be desirable for a wearable device to receive data with a maximum delay of 10 minutes, it would be necessary in accordance with existing approaches for all devices to connect to the server every 10 minutes. However, in accordance with the present disclosure, this can be reduced to a given device connecting less than once in 16 hours. In this example, a single wearable device across the 16 hour window would previously have used around 30 mAh on connecting to the server, but now will use only 300 µAh for the single connection to server. Whilst the reduction in power is offset by the power consumption of the short-range wireless protocol, this is typically a much lower power consumption given the lower range typically around 20 µA per hour. In the example of 100 animals outlined here, this would mean a reduction in power used of around 98%.

As set out above, an active wearable device is one in which its first transceiver is activated to be able to receive data from the remote data network. The first transceiver could simply passively listen for data being transmitted from the server or it may to establish a connection with the server (e.g. through the exchange of regular signals) to receive the data. Typically the first transceiver will transmit signals via the remote data network. These could simply be system signals such as acknowledgements, or they could also include data sent from the wearable device to the server. Such upload data could relate to the wearable device itself or could have been received over the short-range wireless protocol from another wearable device. In such embodiments therefore, the indirect data communication between the server and inactive wearable devices via active wearable devices can be two-way – i.e. uplink as well as downlink.

The data from the server could take any appropriate form. For example it could comprise information which one or more wearable devices require or instructions for one or more wearable devices to perform a particular operation. In exemplary such embodiments the data from the server comprises instructions for one or more of the wearable devices to activate its first transceiver. The wearable device can then receive data broadcast over the remote data network. This allows the wearable devices to be instructed to be active to receive data from the server at times which they would not have active first transceivers under the rotation scheme, for example allowing the wearable devices to send current metrics to the server on request, or to access the server to be provided with changes to their configuration.

In a set of embodiments the remote data network is a cellular network, in some embodiments the remote data network is a satellite network.

In a set of embodiments the data includes changes to the configuration of the wearable devices. It will be appreciated that once transmitted to an active wearable device, such data can then be disseminated to other devices – or even throughout the whole system by transmitting the data via the short-range wireless protocol. In this way, the individual wearable devices are not required to connect to the server to receive any necessary updates. Changes to the configuration of the wearable devices may include one or more of: changes to the geographical perimeter; changes to the configuration of the correction module; and/or changes to the regular rotation of active devices. Changes to the configurations of the wearable devices can therefore be quickly relayed to all devices. When the data includes changes to the geographical perimeter this means that all animals can receive the update within a short time-frame which helps to avoid the situation whereby some animals which have not yet received an update attempt to follow others which have. It has been appreciated that an animal which is prevented, against its instincts, from moving into a new pasture with the rest of the herd could become distressed.

When the data includes changes to the regular rotation of active devices, the changes may include instructions for the wearable devices to increase the time period between becoming active.

In a set of embodiments the regular rotation means one wearable device is active at any one time, however in other embodiments a plurality of wearable devices may be active at one time. This can help ensure that data is received by all wearable devices quickly even if one of the active devices has problems with connecting to the server. In some embodiments regular rotation of the active wearable device may be according to a predetermined schedule. Each wearable device may be configured to become active at a rate of at least once per day, at least once per hour, or at least once per 30 minutes. In some embodiments a group of wearable devices within range of the short-range communication protocol relative to each other may be considered as a rotation group, and the one or more wearable devices in each rotation group are arranged to regularly rotate which one or more of them is active for receiving data from the central server via the remote data network.

In a set of embodiments the active wearable device sends regular messages to the inactive wearable devices via the short-range wireless protocol even if there is no data from the server to transmit and if the inactive wearable devices do not receive such a message for a predetermined time, they activate the first transceiver to communicate via the remote data network. In this way if a single animal, or a small group of animals, becomes separated from the rest of the animals with wearable devices, such that they are no longer in range of an active device by means of the short-range wireless protocol they can still receive data transmitted from the central server.

The short-range communication protocol may be one of Bluetooth Low Energy (BLE) protocol, Wi-Fi, NearLing, Ultra-wideband (UWB), Zigbee, Z-Wave, Long Range (LoRa) or Long Range Wide area Networking protocol (LoRaWan) or could be a proprietary sub-GHz radio, utilising for example standard 2-GFSK modulation at 868MHx or 915MHz. In some embodiments the short-range communication protocol utilises advertisement packets to transmit data. This allows data to be transmitted by the second transceiver without establishing paired connections with other devices, increasing the efficiency of the transmission of the data. When a wearable device which has received the data then also transmits the same data back out using an advertisement protocol it can help reduce the power load on any wearable device whilst ensuring the data is transmitted across the system to all wearable devices within range of the communication protocol.

In a set of embodiments, the data may be split into a plurality of chunks including a header and a plurality of frames. The active wearable device may confirm to the server that it has received the plurality of frames using information contained in the header, and may transmit the data in chunks via the short-range wireless protocol. The wearable devices may receive the data as the plurality of chunks and reconstruct the frames. In this way larger amounts of data can be transmitted to the wearable devices efficiently.

Typically the power source is a battery but this is not essential and other power sources are envisaged. A plurality of power sources could be provided – e.g. a solar cell could be supplemented by a battery.

It will be appreciated by the skilled person that the wearable device(s) will typically be self-contained units with no physical connection to an external entity, only wireless connections as discussed above.

The disclosure extends to the wearable devices which are configured for use in systems as described herein and thus when viewed from a second aspect the present disclosure provides a wearable device for restricting the movement of an animal and configured to be attached to the animal, the wearable device comprising:

i) a first transceiver arrangement for sending and receiving data to/from a remote data network;

ii) a second transceiver arrangement for sending and receiving data via a short-range wireless protocol;

iii) a GNSS module for determining a geographical location of the wearable device;

iv) a correction module arranged to provide a stimulus to the animal based on a distance of the geographical location from the geographical perimeter; and

v) a power supply; and

wherein the wearable device is arranged to selectively activate the first transceiver according to a predetermined schedule, so that the wearable device is regularly active for receiving data from the central server via the remote data network; and

wherein:

i) when active, the wearable device is arranged to receive data from the remote data network, and to transmit the data via the short-range communication protocol; and

ii) when not active for receiving data from the central server, the wearable device is arranged to receive the data via the short-range communication protocol.

The optional and preferred features of the system apply equally to the wearable devices per se.

### BRIEF DESCRIPTION OF THE DRAWINGS

Certain embodiments of the disclosure will now be described, by way of example only, with reference to the accompanying drawings, in which:

FIG. 1 is a schematic illustration of a plurality of wearable devices according to an embodiment of the present disclosure;

FIG. 2 is a schematic illustration of the connectivity of the wearable devices to a server;

FIG. 3 is a schematic illustration of data passing through the system;

FIGS. 4A-4C illustrate implementation of pasture changes using the wearable devices;

FIG. 5 is a schematic illustration of data passing through the system; and

FIG. 6 is a schematic illustration of how data can be transmitted

### DETAILED DESCRIPTION

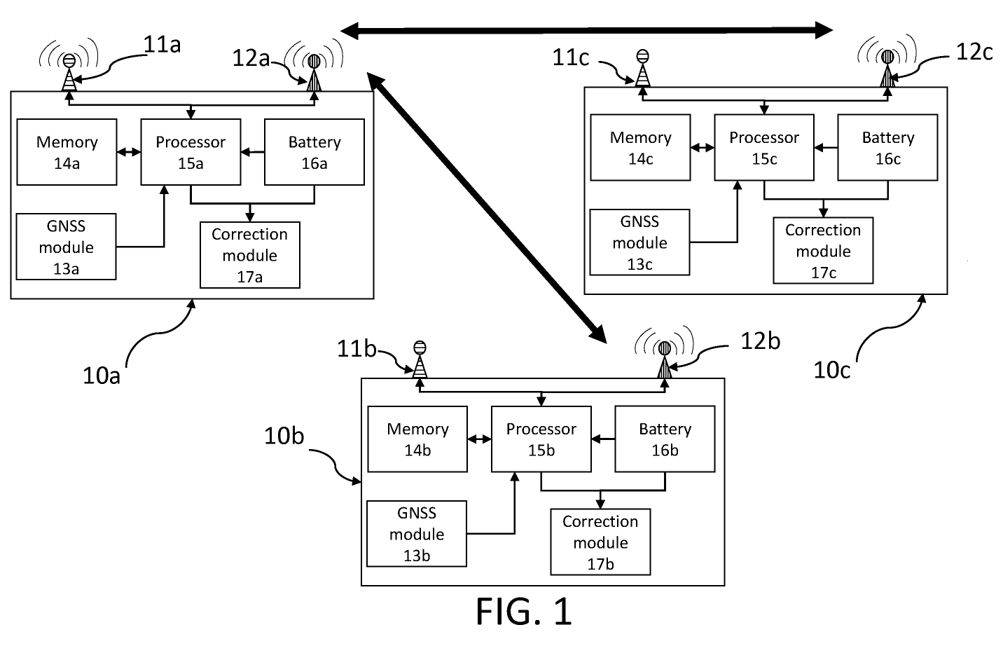

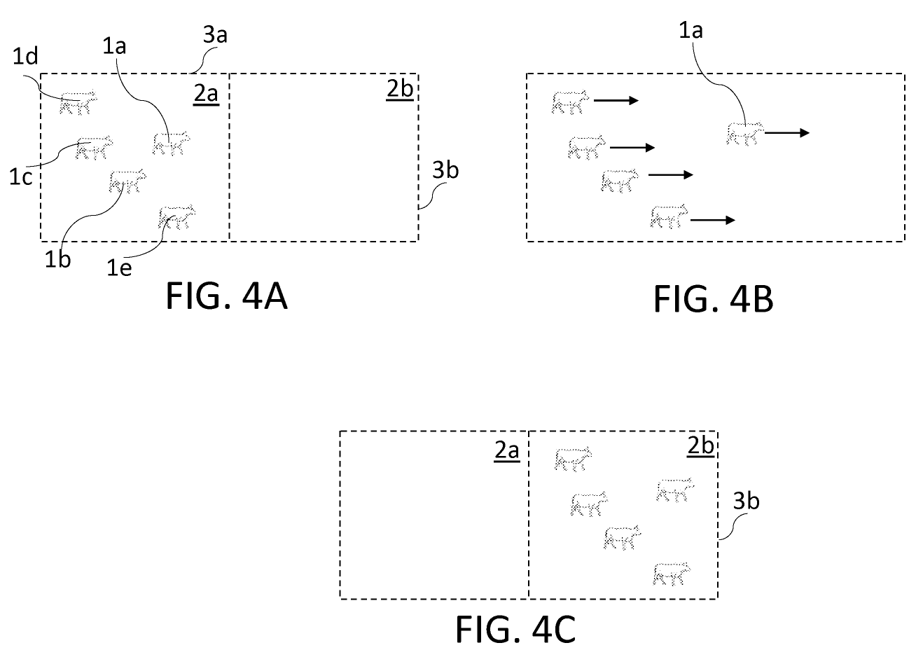

FIG. 1 shows a highly schematic arrangement of a set of wearable devices for use in a system arranged to restrict the movement of animals within a geographical perimeter, as described in more detail below with reference to FIGS. 4A- 4C. In this exemplary embodiment the system includes three self-contained animal collars 10a, 10b, 10c (i.e. device(s) wearable by animals attached to respective animals). Each collar 10a, 10b, 10c includes a first transceiver 11a, 11b, 11c and second transceiver 12a, 12b, 12c and associated digital and analogue components to allow it to transmit and receive data via a remote data network, such as the LTE NB-IoT cellular data network using the first transceiver 11a, 11b, 11c and via short-range wireless protocol such as Bluetooth Low Energy (BLE) using the second transceiver 12a, 12b, 12c. Each collar 10a, 10b, 10c also includes a GNSS module 13a, 13b, 13c which is arranged to monitor (and determine) the current geographical location of the animal wearing the collar 10a, 10b, 10c a memory 14a, 14b, 14c, processor 15a, 15b, 15c, and battery 16a, 16b, 16c (or other power supply). The collars 10a, 10b, 10c also each include a correction module 17a, 17b, 17c which provides a stimulus to the animal dependent on (i.e. based on) its location relative to a distance of the current geographical location from a predetermined geographical perimeter stored in the memory 14a, 14b, 14c. Those skilled in the art will appreciate that there are various types of stimuli which can be implemented in the correction module 17a, 17b, 17c which can be used to restrict the movement of animals, for example audio, haptic and electrical signals. Such operation is described in greater detail in WO 2011/087369. As described above, a variety of short-range communication protocols can be used, and in some embodiments the short-range communication protocol utilises advertisement packets to transmit data. As described above, in a set of embodiments the remote data network is a cellular network, in some embodiments the remote data network is a satellite network.

The collars 10a, 10b, 10c communicate with each other using the second transceiver 12a, 12b, 12c via BLE. They can selectively activate their first transceiver 11a, 11b, 11c to send and receive data using LTE, for example to send and receive data (e.g., instructions) from a server (also referred to as a central server). In this embodiment the first collar 10a is shown with an active first transceiver 11a, and the second and third collars 10b, 10c have inactive first transceivers 11b, 11c. The first collar 10a transmits data received from the server via its second transceiver 12a to the second and third collars 10b, 10c as is explained in more detail below.

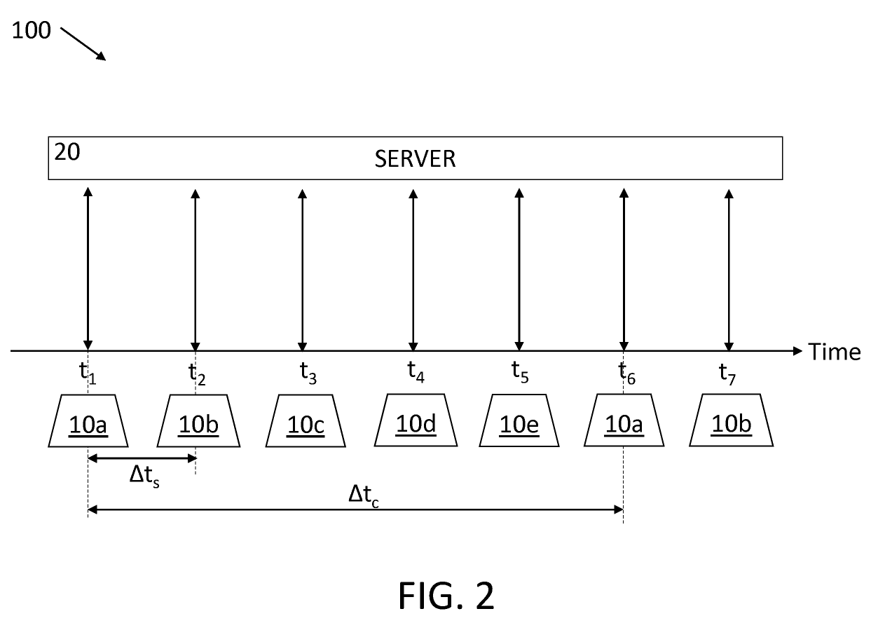

FIG. 2 is schematic illustration of the rotation between multiple collars 10a-10e for connecting to a remote server 20. In this embodiment one collar is shown as connecting to the server 20 at any given time, so the first collar 10a connects to the server at t₁, the second collar 10b connects to the server at t₂ etc. When a collar is shown as connecting to the server, it has an active first transceiver as discussed above with reference to FIG. 1, but when not connected with the server 20 the collar does not have an active first transceiver. In this way the collars sequentially activate and deactivate their first transceiver. The server 20 includes logic which allows the collars to synchronise with the server 20 and with a user application (not shown). The server 20 can include database storage for metrics received from collars 10, and handle interpretation of data received from the collars 10.

Within the system 100 the collar 10 which connects to the server 20 regularly rotates between the collars. In this embodiment one of the collars 10 will connect to the server 20 at an interval of _{s,} for example every 10 minutes, but each collar will only connect to the server 20 at an interval of _{c}, which would be every 50 minutes in this example. This reduces the amount of time each individual collar 10 has an active transceiver for sending and receiving data over the remote data network. Even with only five collars in the illustrative example, there is a five fold reduction in average connection time for each collar and commensurate reduction of power consumption. Of course, in a more realistic system there may be tens or hundreds of collars, giving the potential for even more significant reductions in power consumption.

It will be appreciated that whilst in this illustration a two-way connection to the server 20 is established, in some embodiments the active collar will be open to receive data from the server but will not actively connect to the server. Connectivity to the LTE data network can allow for the current location of an animal to be updated to the server, or other animal metrics monitored by the collar 10 to be sent to the server. Connectivity may also allow for information to be passed to the collar for it to adapt or change its operational parameters, for example to update current pasture information for the collar 10, which will indicate a different geographical perimeter where the animal is currently allowed.

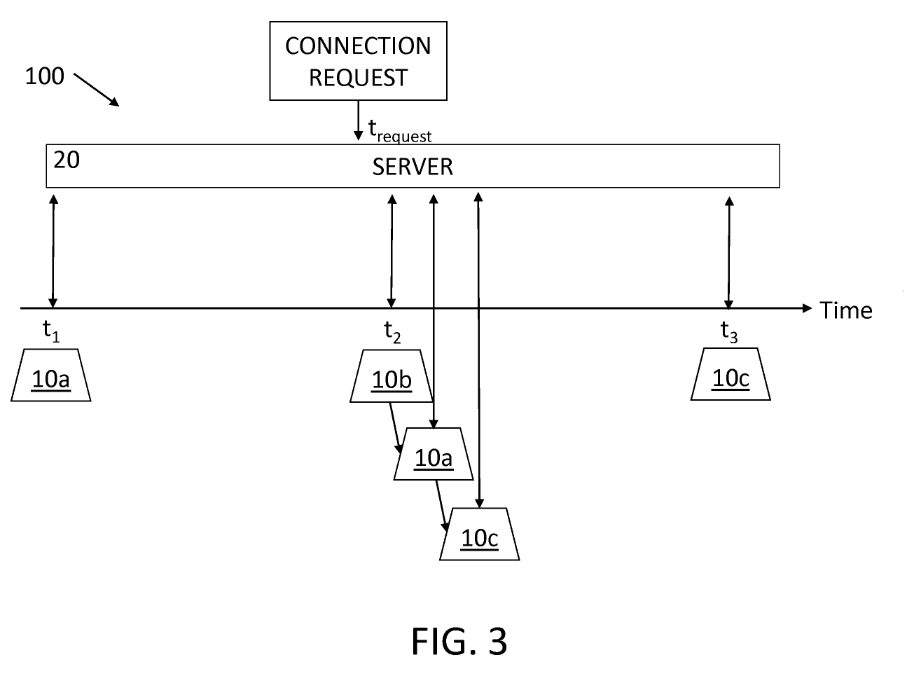

FIG. 3 shows how data received from the server 20 by one collar is propagated to the other collars. At t_{request} a user initiates a request with the server 20, for example a request for the pasture information to be updated or for the current location of each animal to be reported. The second collar 10b is the next collar to activate its first transceiver 11b at t₂, so the second collar 10b receives the request from the server 20 first. The second collar 10b then responds to the request itself (e.g. by sending an update of its current geographical location to the server 20), and it also transmits the same request via BLE using its second transceiver 12b. Other collars e.g. collar 10a, within range of the BLE signal of the second collar 10b, receive the request, then activate their first transceivers 11a to respond to the request e.g. by sending their current geographical location to the server, or to receive data directly from the server. In this example the first collar 10a having received the request from the second collar 10b, then re-transmits the request via BLE using its second transceiver 12a. The third collar 10c then receives the request from the first collar 10a. In this way the request may be distributed to all collars within the system and the geographical range of animals which can receive the request is optimised. Once the response to the request from all relevant collars has been completed the rotation of which collar is active returns to the regular rotation (e.g., rotation performed according to a predetermined schedule, as described above).

FIGS. 4A, 4B and 4C illustrate how the embodiment of the present disclosure described above can be used to implement a change in pasture with a herd of cattle. In FIG. 4A, five cows 1a, 1b, 1c, 1d, 1e each wearing collars (not shown) are in a first pasture 2a defined by a first geographical perimeter 3a, which is separated from a second pasture 2b defined by a second geographical perimeter 3b. Movement of the cows 1a-1e is restrained within the first geographical perimeter 3a by the use of the correction module 17 on each collar 10 (see FIG. 1). As discussed above with reference to FIG. 1, the location of each animal is tracked via GNSS, and their current location is monitored relative to the current definition of their pasture (e.g. the first pasture 2a) recorded in the memory as the first geographical perimeter 3a.

A user can initiate a pasture move remotely e.g. via a user device (not shown), which is communicated to the server. This is then passed on to the individual collars using the mechanism described above with reference to FIG. 3

When the collar 10 for each cow 1a-1e receives data relating to the new pasture definition the geographical perimeter recorded in the respective memory 14 is changed accordingly. In this embodiment, the boundary between the first pasture 2a and the second pasture 2b is removed as shown in FIG. 4B to allow the cows 1a-1e to move without restriction into the second pasture. Once the first cow 1a has moved through the previous boundary, the other cows 1b-1e will follow due to their herding instincts. The first cow 1a is likely to move through the removed boundary due to their instinct to seek out areas with more grass, water or other necessities. Cows and other herding animals naturally group together and follow the behaviour of the majority of the group, which means that once one cow 1a has moved into the newly available pasture, the other cows 1b-1e will be inclined to follow. By disseminating the data relating to the new pasture boundaries between the collars via BLE, this update can happen much faster than waiting for each collar to connect directly to the server. This avoids the potential problem whereby some animals have received the update so can cross what was previously part of a pasture’s geographical perimeter, while other animals within the herd may not have received the updated pasture information. In this scenario, an animal may try to cross the old geographical perimeter with the rest of the herd, but be prevented from doing as it is still a current geographical perimeter for that animal’s collar which might cause distress.

Once all the cows 1a-1e have moved into the second pasture 2b the separation boundary can be reinstated so the cows 1a-1e are now restricted within the second geographical perimeter as shown in FIG. 4C.

In order to reduce the latency in the updating of collar information, and to ensure the natural instincts of the animal can be taken advantage of, the system 100 of FIG. 2 is supplemented with additional protocols to ensure no animal is left behind.

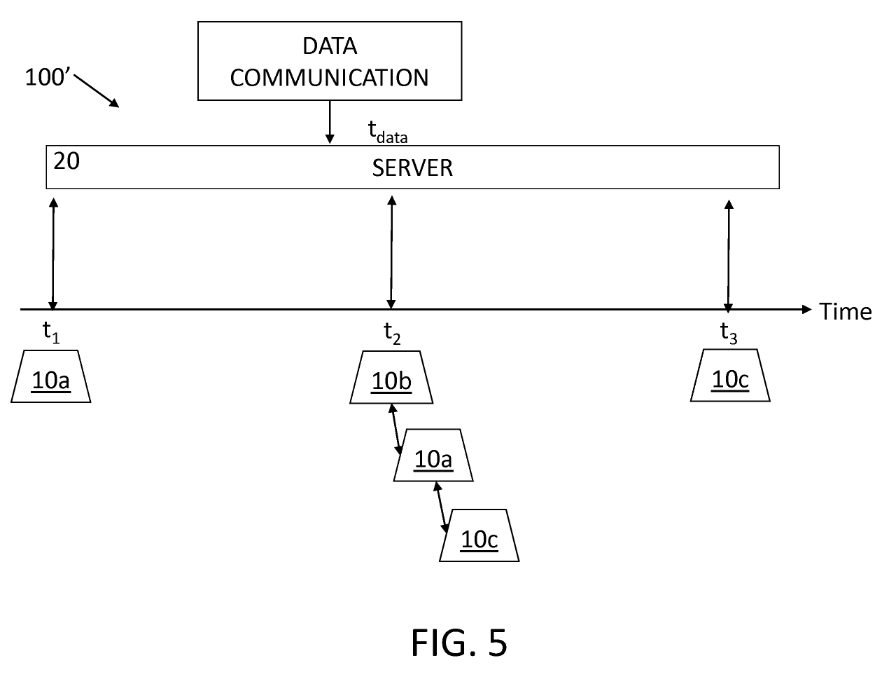

FIG. 5 shows another mode of operation. In this embodiment the same rotation of active collars is used as discussed above with reference to FIG. 2. In the same way as FIG. 3, each collar regularly activates its first transceiver to allow for data to be sent and received from the server 20. In this mode, when the second collar 10b activates its first transceiver at t_{2,} and receives the data from the server 20, for example a new pasture definition, it transmits the new pasture data via BLE using its second transceiver to both the first and third collars 10a, 10c which are inactive with respect to LTE transmissions. This is made possible because both of the other collars 10a, 10c are in Bluetooth range of the second collar 10b, but of course the data can be propagated further by any collar which has received it.

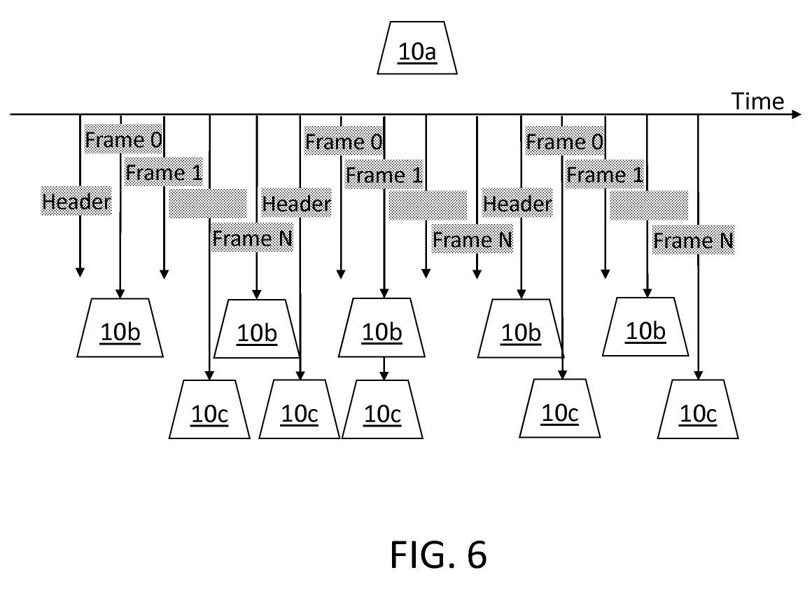

It will be appreciated that the binary file size of a pasture definition (i.e. the definition of the geographical perimeter) depends on the number of vertices which make up the definition. If the geographical perimeter were a simple triangle, the definition of the pasture would be very small, however in reality the pasture definitions will often have complex shapes to reflect the local geography which means that the definition of the pasture itself will include a significant amount of data. FIG. 6 shows how the definition of the geographical perimeter can be packaged for sending without the need for handshake protocols between the collars 10. The server 20 splits the definition of the geographical perimeter (e.g. the pasture definition) into a number of chunks, including a definition header and a plurality of frames, and then transmits the definition in sequence to the active collar, in this example first collar 10a. The first collar 10a as active collar receives all the frames and the definition header, and with the definition header it reconstructs the frames to ensure it has received the whole definition from the server 20 (and confirms, to the server, receipt of the plurality of frames, as described above). The first collar 10a then transmits the definition in sequence via BLE, looping the sequence for a predetermined amount of time as shown, for any inactive collars to receive. The first collar may divide the definition up into different chunks than those received from the server – e.g. to suit the BLE payload size. The chunks can therefore be independent of those received from the server.

The second and third collars 10b, 10c each receive the definition in different orders depending on when the signal from the first collar reaches each collar, and if the data in the signal is interrupted at any point. The information contained in the definition header will provide the collar with the information needed to know when the received definition is complete. Once an inactive collar (e.g., at least one inactive collar) has received the full definition, it is able to update the definition in its memory and transmit the definition via BLE for other collars to receive. All of the collars 10a, 10b, 10 decode the chunks of data to implement a received geographical perimeter, whether received directly from the server 20 or indirectly from another collar.

For an animal to receive any new data (e.g. request, pasture definition, configuration change etc.) generally the collar 10 needs to either be active for receiving data via LTE, or via BLE. The regular rotation of which collar 10 has an active first transceiver 11 for connecting to the server 20 allows for power consumption of each collar 10 to be optimised. It will be appreciated that the systems described above with reference to FIGS. 3 and 5 can be combined, so that for some data transfers each collar 10 will respond by connecting with the server 20, but for other data transfers the data will be decimated across the network of collars 10 without the need to each to connect to the server 20.

The regular rotation of which collars have an active first transceiver 11 can be arranged in a variety of different ways. It will be appreciated that implementing some long-range BLE protocols typically have a line of sight range of up to 100m, which is limited by the efficiency of antenna and noise introduced by internal electronics to the signals. Whilst the embodiments above have been described as using BLE, other short-range wireless protocols, or short-range communication protocols, may also be used. As discussed above, animal instinct tends to mean that animals within a herd stay within a short distance of each other, however there may be some reasons why some animals may stray from the rest of the herd, or the herd may split into distinct groups. This may mean that one or more animals move out of range of BLE, or any other short-range wireless protocol being used. In such scenarios, animals within the BLE range of the short-range wireless protocol with other animals can be considered part of a rotation group, and the rotation of which collar(s) is/are active regularly rotates within the group. Therefore, if a single animal strays beyond the range of other animals within the herd – which might be detected through not receiving regular connection messages from another collar which is either active or in range of an active collar, it will form its own group, and therefore remain with an active first transceiver 11 to ensure it does not miss any changes from the server 20. If it later returns to be within range of another animal it can become part of that group and rotate being the active collar with those animals. In this way the regular rotation of active collars takes into account the movement of animals relative to the other animals, and every collar has a way of receiving any updates from the server.

The rotation of which collar 10 is active can also be dictated by the user via data transferred to the collars 10 from an update sent to the server 20. For example, the data may include an indication that a less frequent communication with the server 20 is required, or that no collar 10 needs to become active for a predetermined amount of time

It will be appreciated by those skilled in the art that the disclosure has been illustrated by describing one or more specific aspects thereof, but is not limited to these aspects; many variations and modifications are possible, within the scope of the accompanying claims.

What is claimed is:

1. A system for restricting movement of animals within a geographical perimeter, the system comprising:
a) a plurality of wearable devices, each wearable device being configured to be attached to an animal, and comprising:
i) a first transceiver arrangement for sending and receiving data to/from a remote data network;
ii) a second transceiver arrangement for sending and receiving data via a short-range communication protocol;
iii) a GNSS module for determining a geographical location of the wearable device;
iv) a correction module arranged to provide a stimulus to the animal based on a distance of the geographical location from the geographical perimeter; and
v) a power supply; and
b) a central server arranged to communicate with the plurality of wearable devices via the remote data network,
the plurality of wearable devices being arranged to regularly rotate which one or more of the wearable devices is/are active wearable device(s) for receiving data from the central server via the remote data network;
wherein:
i) the central server is arranged to transmit data via the remote data network;
ii) the active wearable device(s) is/are arranged to receive the data from the remote data network, and to transmit the data via the short-range communication protocol; and
iii) at least one inactive wearable device which is not active for receiving data from the central server is arranged to receive the data via the short-range communication protocol.

2. A system as claimed in claim 1, wherein the data from the central server comprises instructions for one or more of the inactive wearable devices to activate the first transceiver thereof.

3. A system as claimed in claim 1, arranged to establish two-way data communication between the central server and at least one of the inactive wearable devices via the one or more active wearable devices.

4. A system as claimed in claim 1, wherein the data from the central server comprises changes to a configuration of one or more of the wearable devices.

5. A system as claimed in claim 4, wherein the data comprises one or more of: changes to the geographical perimeter; changes to a configuration of the correction module; and/or changes to the regular rotation of active devices.

6. A system as claimed in claim 1, wherein the regular rotation of the one or more active wearable devices is performed according to a predetermined schedule.

7. A system as claimed in claim 1, wherein a group of wearable devices within range of the short-range communication protocol relative to each other comprise a rotation group; and
wherein the wearable devices in said rotation group are arranged to regularly rotate which one or more of them is active for receiving data from the central server via the remote data network.

8. A system as claimed in claim 1, wherein the one or more active wearable device(s) is/are arranged to send regular messages to the at least one inactive wearable device via the short-range communication protocol even if there is no data from the central server to transmit, said at least one inactive wearable device being arranged to activate the first transceiver thereof to communicate via the remote data network if it does not receive said regular messages for a predetermined time.

9. A system as claimed in claim 1, wherein the data is split into a plurality of chunks including a header and a plurality of frames, wherein the one or more active wearable device(s) is/are arranged to:
i) confirm, to the central server, receipt of the plurality of frames using information contained in the header, and
ii) transmit the data in chunks via the short-range communication protocol; and
wherein the one or more inactive wearable devices is arranged to reconstruct the frames from the plurality of chunks.

10. A system as claimed in claim 1, wherein the short-range communication protocol utilises advertisement packets to transmit data.

11. A system as claimed in claim 1, wherein the remote data network is a cellular network or a satellite network.

12. A wearable device for restricting movement of an animal and configured to be attached to the animal, the wearable device comprising:
i) a first transceiver arrangement for sending and receiving data to/from a remote data network;
ii) a second transceiver arrangement for sending and receiving data via a short-range communication protocol;
iii) a GNSS module for determining a geographical location of the wearable device;
iv) a correction module arranged to provide a stimulus to the animal based on a distance of the geographical location from a geographical perimeter; and
v) a power supply; and
wherein the wearable device is arranged to selectively activate the first transceiver according to a predetermined schedule, so that the wearable device is regularly active for receiving data from a central server via the remote data network; and
wherein:
i) when active, the wearable device is arranged to receive data from the remote data network, and to transmit the data via the short-range communication protocol; and
ii) when not active for receiving data from the central server, the wearable device is arranged to receive the data via the short-range communication protocol.
